(19) United States
(12) Patent Application Publication
(10) Pub. No.: US 2025/0357496 A1
(43) Pub. Date: Nov. 20, 2025

(54) Electrochemical device suitable to work both as electrolyser and fuel cell

(71) Applicants: MIPRONS SRL, Segni (IT); CONSIGLIO NAZIONALE DELLE RICERCHE, Roma (IT)

(72) Inventors: Alberto FIGOLI, Roma (IT); Johannes Carolus JANSEN, Roma (IT); Enrica FONTANANOVA, Roma (IT); Elisa ESPOSITO, Roma (IT); Roberto JERACE, Roma (IT); Mariagiulia LONGO, Roma (IT); Angelo MINOTTI, Segni (IT)

(73) Assignees: CONSIGLIO NAZIONALE DELLE RICERCHE, Roma (IT); MIPRONS SRL, Segni (IT)

(21) Appl. No.: 18/871,465

(22) PCT Filed: Jun. 6, 2023
(86) PCT No.: PCT/IB2023/055819

§ 371 Date: Dec. 3, 2024

(30) Foreign Application Priority Data
Jun. 7, 2022 (IT) 102022000011999

(51) Int. Cl. H01M 4/86; C25B 9/015; C25B 9/19; C25B 11/032; C25B 15/08; H01M 8/04082; H01M 8/04119; H01M 8/10; H01M 8/18

(52) U.S. Cl. CPC H01M 4/8626; C25B 9/015; C25B 9/19; C25B 11/032; C25B 15/08; H01M 8/04156; H01M 8/04201; H01M 8/186; H01M 2008/1095

(57) ABSTRACT

An electrochemical device suitable to work both as electrolyser and fuel cell has a housing (10), a central tubular electrode (11) provided with a plurality of through holes (13) and having a first electrical connector (6) that is connected to an electrical supply or an electrical load, a first gas diffusion layer or GDL (2), a catalyst coated membrane for exchanging of ionic species or CCM (3), which is wound on the first gas diffusion layer or GDL (2), a second gas diffusion layer or electrode-GDL (4), wound on the catalyst coated membrane or CCM (3) and provided with a second electrical connector (5). The first gas diffusion layer or GDL (2), the catalyst coated membrane or CCM (3), and the second gas diffusion layer or electrode-GDL (4) are suitable to surround the central tubular electrode (11) for at least 360°.

### FIELD OF THE INVENTION

The present invention relates to an electrochemical device suitable to work as both an electrolyser and a fuel cell. More specifically, the invention concerns an electrolyser having a tubular or spiral structure with a high packing density based on ion exchange membranes.

An electrolytic cell or electrolyser makes it possible to convert chemical substances by breaking them down into simpler substances through the use of electricity. In other words, an electrolyser converts electrical energy into chemical energy. The conversion process from electrical energy to chemical energy can be reversible in a so-called fuel cell where chemical energy is transformed into electrical energy.

A method of producing hydrogen is the electrolysis of water which uses electricity without the use of toxic reagents and the production of polluting by-products or CO₂ emissions. Electrolysis requires low voltage direct current; therefore, the electrolytic cells or electrolysers can be powered by renewable energy such as solar or wind power. The method, considered environmentally sustainable, allows the storage of excess renewable energy and allows consumers to use the excess energy even when there is no wind or sun.

### BACKGROUND ART

The electrolytic cells most used for the production of hydrogen exploit the process of electrolysis of water assisted by a solid polymeric electrolyte, such as an ion exchange membrane. In particular, the use of proton exchange membranes (Cation Exchange Membrane—CEM and, generically, Proton Exchange Membrane or Polymer Electrolyte Membrane—PEM) allows to achieve high energy efficiency and power density; anion exchange membranes (Anion Exchange Membrane—AEM) allow the use of low-cost catalysts to conduct the electrolytic process and generally have high durability.

The PEM membrane allows the selective transport of protons or the AEM membranes allow the transport of hydroxyl ions, respectively from the anode to the cathode and from the cathode to the anode of the electrolytic cell. Both types of membranes, PEM and AEM, perform a barrier effect towards the gases produced (only H₂ and O₂ for the electrolysis of water) so to allow their separation.

There are also ion exchange membranes covered on both sides with a layer of catalyst (Catalyst Coated Membrane, CCM).

The electrolytic cell is connected to a direct current power supply which allows the catalytic oxidation at the anode and the catalytic reduction at the cathode, according to the following general reaction:

$$2 {H}_{2} O + energy \to 2 {H}_{2} + {O}_{2}$$

These types of electrolysers make it possible to generate gases at pressures sufficient for their storage without the need for mechanical compression.

For making the electrodes, metals or their alloys are generally used to form nets or plates. Electrocatalysts, i.e. compounds that increase the rate of reactions at the electrodes, can also be used. Currently commercially available electrolysers consist of two half-cells containing electrodes, the two half-cells being separated by a porous septum through which liquid electrolyte circulates. This structure does not allow for the clean and physical separation of hydrogen and oxygen. On the contrary, electrolysers with ion exchange membranes allow the production of the two gases in two completely separate compartments. For example, membranes based on perfluorinated-sulphonated polymers such as Nafion® and Aquivion® act as a physical barrier between the two gases with the possibility of producing them at high differential pressures. Membrane electrolysers are generally characterized by flat circular or flat square structures and involve the use of a single flat membrane or flat membranes housed in series in a parallel manner. By the way, see S. Shiva Kumar, V. Himabindu, Hydrogen production by PEM water electrolysis—A review, Mater. Ski. Energy Technol. 2 (2019) 442-454. The diffusion of these devices on an industrial scale is still limited by the scarcity and high cost of the materials used to assemble the electrolyser. Furthermore, the production of membrane electrolysers capable of operating at high energy efficiency with high currents involves the use of membranes with large surfaces in order to be able to disperse the charge and have low current densities. This involves the production of large electrolysers that can accommodate a large active surface area of a single flat membrane or a cell with multiple stacked membranes.

US 2010/0089747 discloses a high pressure electrolyser. A cylinder acting as an external electrode has a water inlet and a gas outlet. A conductive center pin serves as the center electrode, partially contained within the outer electrode. The outer electrode and the central electrode can be, alternatively, an anode electrode or a cathode electrode. The outer electrode and the center electrode are electrically coupled to each other via a DC power source. A membrane electrode arrangement is spirally wound around the center electrode within the outer electrode. A non-permeable separating layer is wrapped separately around the center electrode and may be bonded to either the center electrode or the outer electrode. The non-permeable separator layer prevents electrical contact between remote portions of the membrane electrode arrangement, and substantially prevents the flow of water, or oxygen gas, or hydrogen gas, or hydrogen ions therethrough. The possible addition of a compartment for the collection of H₂ and O₂ and possible extraction of H₂ and O₂ by gravity is provided. The arrangement of the electrodes and of the separating layer in US 2010/0089747 is not efficient; in fact, it does not allow to exploit the entire active area of the membrane. In particular, since the external electrode is wrapped as a single layer together with the membrane, there are points of non-contact between the two elements. This means that part of the membrane area is not active for the electrolytic process. At the same time, the electrolyser according to US 2010/0089747 does not allow for a clean separation of the product gases.

U.S. Pat. No. 6,890,410 B2 describes an apparatus for converting a liquid, such as water, into oxygen and hydrogen, with an electrode encapsulation system. The system allows electrodes with opposite charges to be located in intimate contact with each other to increase ion flow and electron flow, and correspondingly increase gas generation. Preferably an envelope of flexible material is used, folded along one edge to completely encapsulate an electrode. In an embodiment, the apparatus includes a housing defining a chamber which may be filled with water and in which an encapsulated electrode and a nonencapsulated electrode, rolled from end to end, are immersed. A flexible metal tube feeds water into the envelope, and an end thereof is connected to a positive side of a direct current source. An end of the flexible metal tube passes through a cover of the housing, while another conduit passes through the cover and opens into the chamber. A negative side of a current path is connected to the nonencapsulated electrode circuit. As electrolysis occurs during the flow of electrons, oxygen bubbles are generated within the encapsulated electrode particularly within the housing, while bubbles of hydrogen gas are generated on the surfaces of the negatively charged electrode. The oxygen and hydrogen produced are transported separately through these conduits to storage facilities or for direct use. In U.S. Pat. No. 6,890,410 B2, the collection tanks for hydrogen and oxygen are external to the electrolyser. Furthermore, the electrodes are encapsulated in an electro-deposited, silk-screened and relatively flexible material, which therefore requires several complex and expensive preparation steps. Furthermore, the U.S. Pat. No. 6,890,410 B2 provides for a simple immersion of the electrolyser in an electrolyte and/or water without providing for a recirculation of water which is necessary to promote the removal from the membrane of the gases produced and to constantly hydrate the membrane and allow its correct functioning.

WO 2005100639 A1 discloses a gas generator by electrolysis which separately takes out oxygen and hydrogen. The gas generator comprises a tubular electrode holding an electrolyte, a center electrode concentrical to the tubular electrode, a tubular in-termediate electrode disposed concentrically between the center electrode and the tubular electrode, and caps closing the openings at both ends of the tubular electrode and the center electrode. A direct current voltage is applied and an electric field is produced between the center electrode and the electrode tube. Owing to this electric field, hydrogen gas and oxygen gas are generated at the circumferential surfaces of the center electrode, the tubular electrode and the intermediate electrode. The hydrogen gas and oxygen gas are separately discharged. Simple ion exchange membranes are used which are protected by a protective element to maintain the proper humidity.

At present, the high cost of electrolysers, due mainly to the high cost of the materials that constitute them and to the complexity of their assembly, limits their sale and diffusion. Furthermore, present membrane electrolysers have a low packing density, therefore they require the use of large membrane areas, necessary to operate even at high currents while maintaining a low current density (A/cm²).

### SUMMARY OF INVENTION

The main object of the present invention is to overcome the drawbacks of the devices described in the cited documents.

Another object of the invention is to provide a system in which the membrane itself acts as a separator between the gases produced, thus avoiding the presence of two distinct compartments for the differentiated collection of oxygen and hydrogen.

These objects are achieved by an electrochemical device able to work as both an electrolyser and a fuel cell, comprising
a housing, equipped with at least two connection ducts for the inlet or the outlet of both reagents or reaction products,
a central tubular electrode, provided with a plurality of through holes and located in the housing, the central tubular electrode having end openings for the inlet or the outlet of reagents or reaction products, and a first electrical connector, connected to a system selected from the group comprising an electrical power supplier and an electrical load,
a first gas diffusion layer,
an ion exchange membrane wound on the first gas diffusion layer,
a second diffusion layer, wound on the ion exchange membrane and equipped with a second electrical connector which is connected to said selected system,
the first gas diffusion layer, the ion exchange membrane, and the second diffusion layer being suitable to surround the central tubular electrode for at least 360°.

Essentially, the advantage of the device according to the present invention is the possibility of operating at high energy efficiency while keeping the weight and dimensions of the device low, thanks to the high packing density for the tubular or spiral structure.

Due to its small size, the device according to the invention can be used in a small modular unit for the production of hydrogen at the point where hydrogen is required by the user.

Furthermore, its structure eliminates many of the costs and complexities of the conventional electrolytic cell.

Furthermore, the proposed structure allows to have a self-pressurizing electrolytic system through the use of outlet valves of the gases produced as a function of time, current density and collection volume in the electrode of the support, central and external, which act as collection tanks integrated into the system itself.

Another advantage of the device is represented by the simplicity of the steps which allow its realization and this could ensure a greater diffusion of membrane electrolysers on the market.

### BRIEF DESCRIPTION OF DRAWINGS

Further characteristics and advantages of the invention will become most evident from the description of embodiments of the electrochemical device suitable for working as both an electrolyser and a fuel cell, illustrated by way of indicative and non-limiting example in the attached drawings in which:

FIG. 1 is a schematic perspective view in transparency of a first embodiment of the electrochemical device according to the invention with the function of an electrolyser.

FIG. 2 is a schematic perspective view in transparency of the first embodiment of the electrochemical device according to the invention with the function of a fuel cell.

FIG. 3 is a schematic cross-section view of the first embodiment of the electro-chemical device and shows its internal components.

FIG. 4 is a partially cut away schematic perspective view which highlights the different components of the first embodiment of the electrochemical device.

FIG. 5 is a partially cut away schematic perspective view of a second embodiment of the electrochemical device.

FIG. 6 shows a first step for obtaining the second embodiment of the electrochemical device according to the invention, represented in a schematic cross-section view.

FIG. 7 shows a second step for obtaining the second embodiment of the electro-chemical device according to the invention, represented in a schematic cross-section view.

FIG. 8 shows a third step for obtaining the second embodiment of the electro-chemical device according to the invention, represented in a schematic cross-section view.

FIG. 9 is a schematic partial cut perspective view of a first variant of GDL-electrode and spacer layer in one element.

FIG. 10 is an enlarged detail of a left front edge portion of the first variant of the GDL-electrode and spacer layer in FIG. 9.

FIG. 11 is a schematic partial cut perspective view of a second variant of GDL-electrode and spacer layer, including hydrophobic membranes.

FIG. 12 is an enlarged detail of a left front edge portion of the second variant of the GDL-electrode and spacer layer in FIG. 11.

FIG. 13 is an enlarged detail of a right front edge portion of the second variant of the GDL-electrode and spacer layer in FIG. 11.

### DESCRIPTION OF EMBODIMENTS

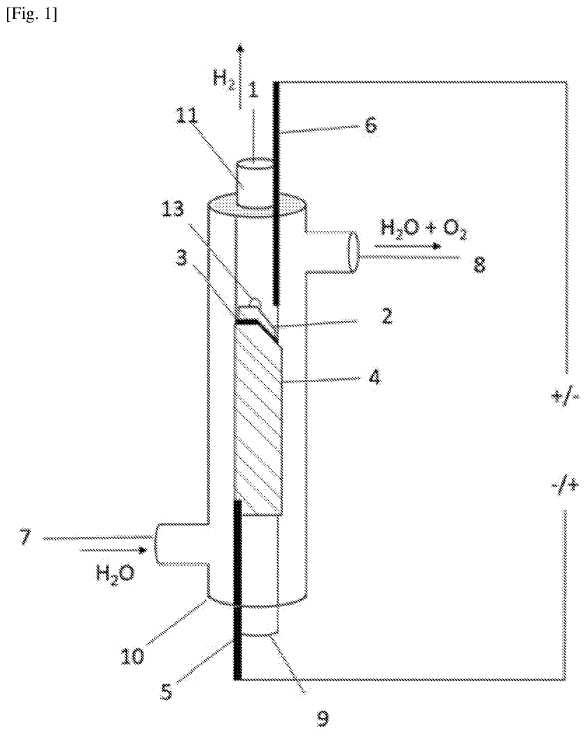

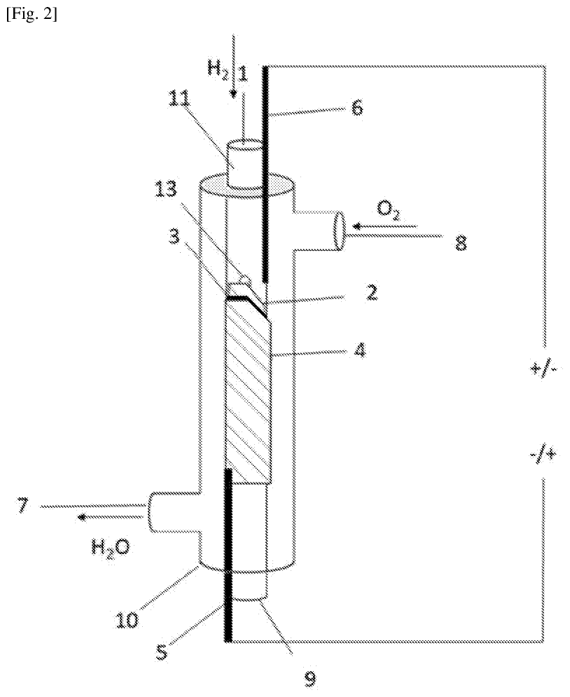

With reference to FIGS. 1 and 2, the electrochemical device, adapted to work respectively as an electrolyser and as a fuel cell, comprises a housing 10, which has a tubular shape closed at the ends. The housing 10 is equipped with two connection ducts schematically represented as directed transversely towards the outside of the housing, indicated respectively as 7 and 8 and intended for the inlet or outlet of reagents or reaction products.

A central tubular electrode 11 is located inside the housing 10. The central tubular electrode 11 has a cavity with end openings 1, 9, shown schematically, and also intended for the inlet or outlet of reagents or reaction products. The central tubular electrode 11 is equipped with a plurality of through holes 13 and is provided with a first electrical connector 6.

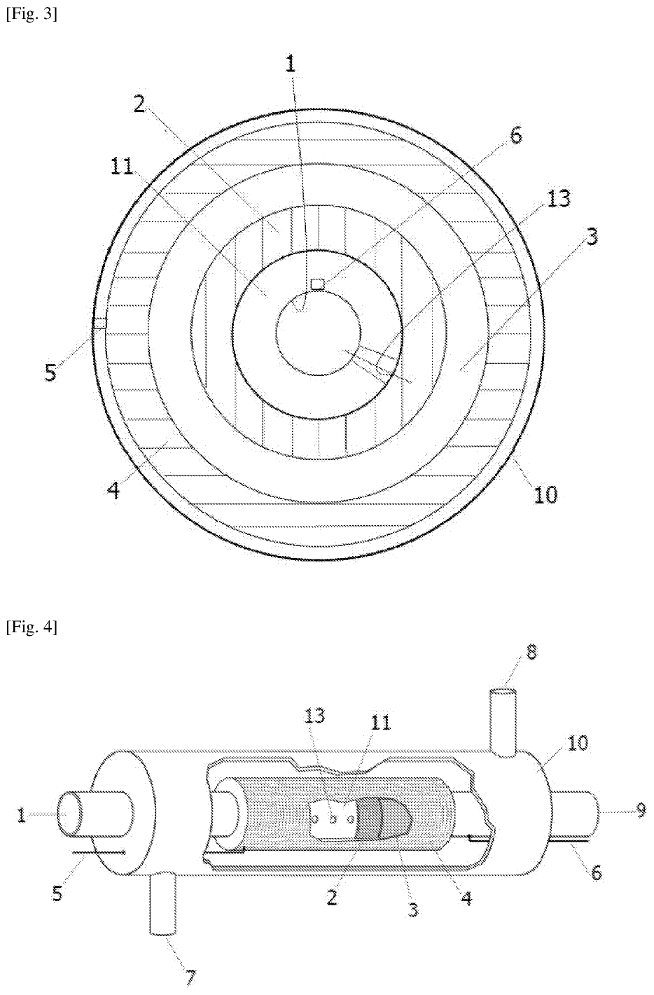

Reference is made also to FIGS. 3 and 4, which are a partial schematic cross section view and a schematic perspective view, partially cut away from the side, of the first embodiment of the electrochemical device shown in FIG. 1. Note in particular that in FIG. 3 the connection ducts 7 and 8 are not shown.

An ion exchange membrane 3 covered on both sides by a catalyst layer, already referred to above as CCM (Catalyst Coated Membrane), is wound onto the central tubular electrode 11. A first gas diffusion layer or GDL (gas diffusion layer) 2 is interposed between the central tubular electrode 11 and the CCM 3. A second gas diffusion layer also having the function of electrode or GDL-electrode 4 surrounds the CCM 3 for 360°, and is equipped with a second electrical connector 5.

It should be understood that the core of the device consists of the CCM 3 wound around the central tubular electrode 11, which has a load-bearing function, also of support for the CCM 3. Interposed between the CCM 3 and the central tubular electrode 11 is the GDL 2, which is flexible and conductive, works as a current distributor and facilitates the diffusion of gases. The GDL-electrode 4, which is flexible and conductive, surrounds the CCM 3 and, for this reason, is also called external GDL. The GDL 2, the CCM 3 and the GDL-electrode 4 are able to surround the central tubular electrode 11 for at least 360° defining a tubular structure of the electrochemical device.

The central tubular electrode 11, the GDL 2, the GDL-electrode 4 and the CCM 3 are positioned inside the housing 10, which can be removed so as to allow operations to restore or replace the GDL 2, the GDL-electrode 4 and the CCM 3. The electrical connectors 6 and 5 are respectively anchored to the central tubular electrode 11 and to the GDL-electrode 4.

In operating mode as electrolyser of the electrochemical device according to the present invention, the electrodes are connected to an external direct current power supply. In fuel cell mode, the device is connected to an external electrical load or energy storage system. In both operating modes, pressure or temperature sensors can be connected to the gas and/or water inlets and outlets for continuous monitoring of the reagents and products. Furthermore, as will be seen below, highly hydrophobic porous membranes can be installed at the gas outlet capable of allowing the passage of gases and, at the same time, hindering the passage of water, so as to have the further advantage of obtaining gas anhydrous from the membrane electrolytic process.

In summary, FIG. 4 represents an axonometric view of the tubular electrolyser of FIGS. 1 and 2, and shows a cutaway view of the internal components: inlet/outlet of reactants/products 1, 7, 8, 9; CCM 3; GDL 2 and GDL-electrode 4, central tubular electrode 11 with holes 13 allowing the entry of reactants/the exit of reaction products.

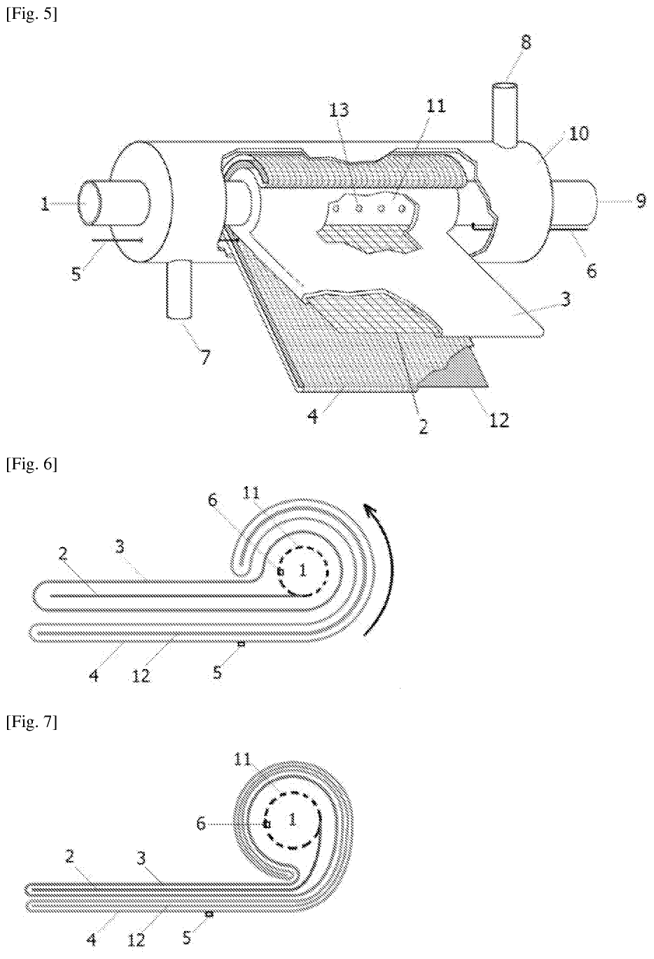

Reference is now made to FIG. 5 which is a partial cutaway schematic perspective view of a second embodiment of the electrochemical device according to the present invention. For convenience, in FIG. 5 the component parts, already present in the first embodiment of FIG. 4, are indicated with the same reference numbers.

Differently from the first embodiment, the layers of the second embodiment of the invention are not arranged in a tubular sleeve shape but spirally wound. In fact, the GDL 2, the CCM 3 and the GDL-electrode 4 are able to surround the central tubular electrode 11 for more than 360° defining a spiral structure of the electrochemical device.

To allow a functional winding, it is necessary that the conductive layers are duly insulated.

The ion exchange membrane or CCM 3 is adapted to surround on each side the central tubular electrode 11 and the first gas diffusion layer or GDL 2.

In this way, the GDL 2 can rewind around the central tubular electrode 11 and on itself, remaining isolated by folding the CCM 3 on it. A spacer layer 12 of electrically insulating material is provided, able to allow the transversal and longitudinal circulation of H₂O and O₂, as will be seen below. In turn, the second diffusion layer or GDL-electrode 4 surrounds the ion exchange membrane or CCM 3. This can be understood more clearly thanks to FIGS. 6, 7, 8, which show three successive steps for obtaining the same electrochemical device, represented in a schematic cross-section view. In these figures the housing 10 is not shown, while the central tubular electrode 11 is represented by the part of its input 1 schematically dotted to highlight the presence of the holes 13. A GDL 2 is in electrical contact with the central tubular electrode 11. The GDL 2 is shown lying flat in FIG. 6. The central electrode tube 11 and the GDL 2 are surrounded on all sides by the CCM 3 with an electrically insulating function.

The second electrode is represented by the GDL-electrode 4 which is arranged in contact with the CCM 3.

To allow the GDL-electrode 4 to be wound on itself, it is sandwiched on the spacer layer 12 of electrically insulating material.

In FIG. 7, the central tubular electrode 11 is rotated a quarter turn integrally with the end of the GDL 2 in contact with it.

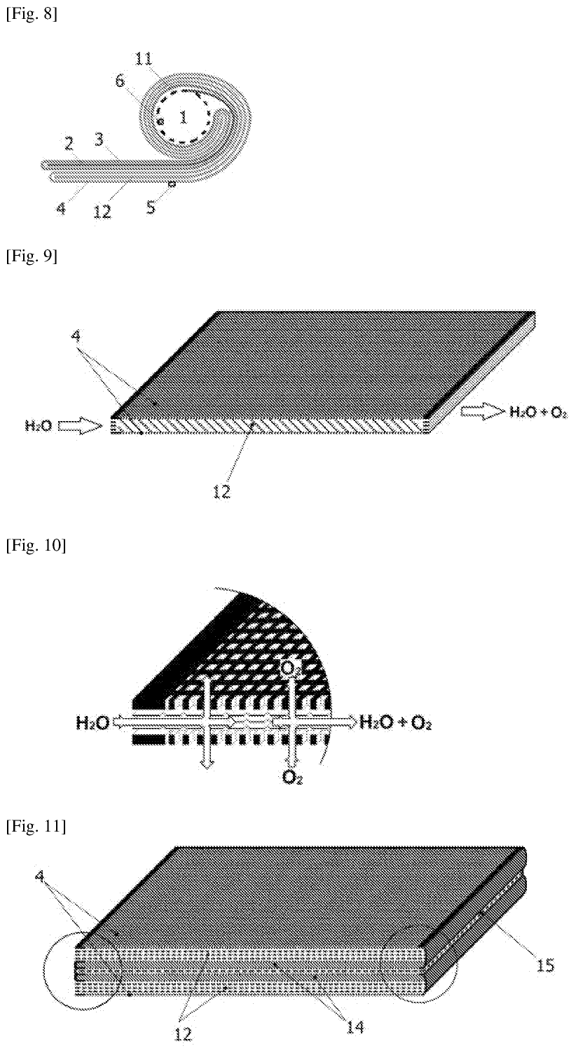

In FIG. 8, the central tubular electrode 11 is rotated approximately a quarter turn with respect to the arrangement of FIG. 7, together with the layers of GDL 2 and GDL-electric 4 and respective insulating layers.

Refer now to FIG. 9 which is a partial cutaway schematic perspective view of a first variant of GDL-electrode and spacer layer in one piece. The spacer layer 12 is covered on both sides by the second diffusion layer or GDL-electrode 4. According to this first variant, the spacer layer 12 and the GDL-electrode 4 form a single element, which is formed from a multilayer material. This material is, at the same time, conductive and permeable to water, so that it can have the dual function of conducting electricity and facilitating the diffusion of gas and water until it reaches the CCM 3. FIG. 10 presents an enlarged detail that shows the transversal and longitudinal circulation of H₂O, up to wetting the CCM 3, and the removal of produced O₂ and of H₂O excess from the CCM 3.

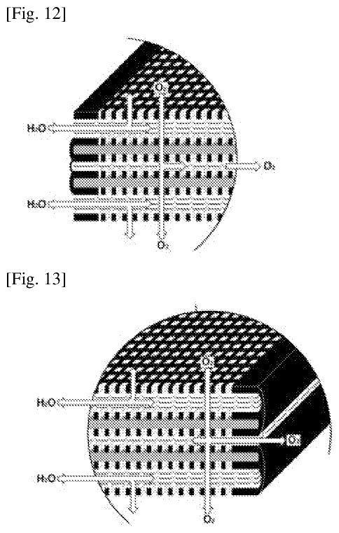

FIG. 11 is a schematic partial cut perspective view of a second variant of GDL-electrode and spacer layer, including hydrophobic membranes, in one element. FIG. 12 and FIG. 13 are an enlarged detail of a left and right front edge portion of the second variant, respectively, of the GDL electrode and spacer layer of FIG. 11. FIG. 12 and FIG. 13 show the H₂O inlet and the oxygen outlet. Compared to the first variant of FIG. 9, the second variant of FIG. 11 has a multi-layered structure which presents, starting from the outside towards the inside:
two conductive layers, corresponding to the electric GDL 4, one of which is intended to come into direct contact with the CCM 3, as shown in FIG. 5,
two spacer layers 12,
two hydrophobic membranes 14 permeable to gases, e
an anhydrous oxygen recovery channel 15, delimited by the two hydrophobic membranes 14.

Then, the hydrophobic membranes are interposed between the respective GDL-electrodes 4-spacer layers 12 and the anhydrous oxygen recovery channel 15. This arrangement allows the recovery of oxygen in anhydrous form.

### Example of Operation as an Electrolyzer

The device with a tubular structure according to the first embodiment of the invention (FIG. 1), functioning as an electrolyser, provides for a recirculation system of the feed water. The water can be fed into the housing 10 from the inlet 7 and recirculated at the outlet 8, or vice versa. In this configuration, the anode consists of the GDL-electrode 4, and the cathode consists of the GDL 2 as it is in contact with the central tubular electrode 11. The hydrogen produced by means of a membrane electrolytic process collects in the cavity of the central tubular electrode 11, following its passage through its holes 13. Instead, the oxygen produced on the anode side diffuses from the CCM 3 through the GDL-electrode 4 until it is collected in the housing 10.

By reversing the polarity of the applied current, the central tubular electrode 11 acts as an anode, and the GDL-electrode 4 as a cathode. The water can be fed from above, from the inlet 1 of the cavity of the central tubular electrode 11 and recirculated downwards into the opening 9, or vice versa. The oxygen produced through a membrane electrolytic process, collects in the cavity of the central tubular electrode 11, on which there are holes 13 for the diffusion of the gas. Instead, the hydrogen produced from the cathode side diffuses from the CCM 3 through the GDL-electrode 4 until it is collected in the housing 10. The dimensions and thicknesses of the various layers making up the electrolyser can be chosen on the basis of specific needs. Moving on to the second embodiment, the device with a spiral structure allows a packing density higher than the tubular one, since the CCM 3 surrounds on each side the central tubular electrode 11 and the first gas diffusion layer or GDL 2, folding back on itself in a spiral together with the GDL-electrode 4. The CCM 3 is in contact with the respective GDLs 2, 4. In particular, the CCM 3 surrounds on each side the GDL 2, the GDL 4 is sandwiched on the spacer layer 12.

The central tubular electrode 11, thanks to the fact that it is equipped with through holes 13, allows the collection of the gas produced or the recirculation of water according to the polarity of the applied current.

The electrochemical device, functioning as an electrolyser, allows to operate at low current densities and therefore to achieve high energy efficiencies. This is made possible by the use of a larger surface area of the membrane, compared to a normal flat electrolyser, more active surface being compacted into a smaller volume. Compared to a multilayer electrolyser, this electrolyser is less heavy and more compact.

### Example of Operation as a Fuel Cell

With reference to FIGS. 2 and 3 of the first embodiment, the device according to the present invention can also operate reversibly as a fuel cell. Specifically, the hydrogen is fed into the cavity of the central tubular electrode 11 and, having passed its holes 13, diffuses through the GDL 2 up to the catalyst present on the surface of the CCM 3. The oxygen, on the other hand, is fed from the inlet 8 in the housing 10 from which it spreads through the GDL-electrode 4 until it reaches the external surface of the CCM 3. The direct current produced by the reaction is sent through the electrical connectors 5, 6 to an external electrical load or to an energy storage system. The water produced leaves the housing 10 through its outlet 7.

By inverting the polarity of the applied current, the central tubular electrode 11 acts as a cathode, and the GDL-electrode 4 as an anode. In this case, the oxygen is fed into the cavity of the central tubular electrode 11 and diffuses, after passing the holes 13, through the GDL 2 up to the catalyst on the CCM 3. The hydrogen, on the other hand, is fed from the inlet 8 in the housing 10 from which, through the GDL-electrode 4, it diffuses until it reaches the external surface of the CCM 3. The direct current produced by the reaction is sent through the electrical connectors 5, 6 to an external electrical load or to a system of energy storage. The water produced is collected in the cavity of the central tubular electrode 11.

Ultimately, the advantages of the electrochemical device with a tubular/spiral structure compared to the flat configuration are the following:
high compactness and packing density understood as a high ratio between the area of the membrane and the volume of the device. The improvement for the spiral structure device is at least a factor of 10;
greater resistance to internal gas pressure (up to 5000 kPa) thanks to the specific geometry. The spiral structure and the packing density allow to redistribute the stress load so as not to cause the device to fail when high pressures are applied.

The device, having a tubular or spiral structure, makes it possible to achieve higher energy efficiencies compared to a flat electrolyser, since with the same current supplied, the current density will be lower, having maximized the active area of the membrane in a smaller volume. The fact that the ion exchange membrane is wrapped, rather than encapsulated, on a flexible electrode increases the contact at the interface between the membrane catalyst and the electrode, which will also act as a gas diffusion layer for both sides, cathode and anode, and also as water dispenser for anode side.

The device allows the recirculation of the water which has two positive aspects: on the one hand it guarantees a faster removal of the gas produced from the surface of the CCM and on the other hand it allows the removal of the potential heat which may be generated during the reaction of electrolysis.

### INDUSTRIAL APPLICABILITY

The present invention finds its natural field of application in systems that require the immediate production and use of H₂ and O₂ by means of a compact-sized device, such as in wearable systems, space applications, mobile systems, thanks to the higher densities of packing of the spiral and tubular structure compared to traditional flat membrane electrolysers.

1. An electrochemical device suitable to work both as electrolyser and fuel cell, comprising
a housing (10), equipped with at least two connection ducts (7, 8) for the inlet or the outlet of both reagents and reaction products;
a central tubular electrode (11), provided with a plurality of through holes (13) and located in the housing (10), the central tubular electrode (11) having end openings (1, 9) for the inlet or the outlet of both reagents and reaction products, and a first electrical connector (6), connected to a system selected from the group comprising an electrical power supplier and an electrical load,
a first gas diffusion layer or GDL (2),
a catalyst coated membrane for exchanging of ionic species or CCM (3), which is wound on the first gas diffusion layer or GDL (2),
a second gas diffusion layer or electrode-GDL (4) also acting as an electrode, wound on the catalyst coated membrane or CCM (3) and provided with a second electrical connector (5) that is connected to said selected system,
the first gas diffusion layer or GDL (2), the catalyst coated membrane or CCM (3), and the second gas diffusion layer or electrode-GDL (4) being suitable to surround the central tubular electrode (11) for at least 360°.

2. The device according to claim 1, characterised in that the electro-chemical device has a tubular configuration in which the first gas diffusion layer or GDL (2), the catalyst coated membrane or CCM (3), and the second gas diffusion layer or electrode-GDL (4) are in the shape of cylindrical sleeves, concentrically arranged in succession from inside to outside around the central tubular electrode (11).

3. The device according to claim 1, characterised in that the electro-chemical device has a spiral configuration in which the first gas diffusion layer or GDL (2), the catalyst coated membrane or CCM (3), and the second gas diffusion layer or electrode-GDL (4) are suitable to surround the central tubular electrode (11) for more than 360°, being spirally wound around the central tubular electrode (11), the catalyst coated membrane or CCM (3) being suitable to surround on each side the first gas diffusion layer or GDL (2).

4. The device according to claim 3, characterised in that the second gas diffusion layer or electrode-GDL (4) is suitable to surround the catalyst coated membrane or CCM (3).

5. The device according to claim 3, characterised in that the electro-chemical device further comprises a spacer layer (12) consisting of an electrically insulating material and covered in both the sides thereof by the second gas diffusion layer or electrode-GDL (4), the spacer layer (12) and the second gas diffusion layer or electrode-GDL (4) being arranged in such a way to allow a transversal and longitudinal H₂O circulation, in order to wet the catalyst coated membrane or CCM (3), and in such a way to permit a removal of O₂ and a H₂O excess from the catalyst coated membrane or CCM (3).

6. The device according to claim 5, characterised in that the spacer layer (12) and the second gas diffusion layer or electrode-GDL (4) are made of a single multi-layered material that is suitable to conduct electricity and to facilitate the diffusion of gas and water.

7. The device according to claim 6, characterised in that the single multi-layered material also comprises
an additional spacer layer (12),
two hydrophobic membranes (14) permeable to gases, delimited by the two spacer layers (12) and
a channel (15) for the recovery of anhydrous oxygen, the channel (15) being delimited by the two hydrophobic membranes (14).
